(19) United States
(12) Patent Application Publication
(10) Pub. No.: US 2015/0065217 A1
(43) Pub. Date: Mar. 5, 2015

(54) WAGERING SYSTEM AND METHOD

(71) Applicant: Chi Fat Au-Yeung, Birmingham (GB)

(72) Inventor: Chi Fat Au-Yeung, Birmingham (GB)

(21) Appl. No.: 14/017,128

(22) Filed: Sep. 3, 2013

(51) Int. Cl. G07F 17/32

(52) U.S. Cl. CPC G07F 17/3267; G07F 17/3293; G07F 17/3244
USPC 463/12

(57) ABSTRACT

A method, apparatus, and computer readable storage to implement a wagering system, method and non-transitory computer readable storage medium. A computer system can implement a gaming methodology wherein a player is dealt a set of cards and splits the set of cards into two separate hands at the player's choice. The dealer is also dealt a set of cards and splits the dealer's cards into two separate hands at the dealer's choice. The high player's hand (higher than the low player's hand) is compared to the high dealer's hand (higher than the low dealer's hand), and the low player's hand is compared to the low dealer's hand. A wager placed by the player at the start of the game is resolved based upon the comparison.

### BACKGROUND OF THE INVENTION

1. Field of the Invention

The present general inventive concept is directed to a method, apparatus, and computer readable storage medium directed to a wagering system.

2. Description of the Related Art

The casino game of Pai-Gow is known in the art, see U.S. Pat. No. 7,487,970, which is incorporated by reference herein in its entirety.

### SUMMARY OF THE INVENTION

It is an aspect of the present invention to provide an exciting casino game.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of implementing a wagering game which always uses two hands each for player and dealer, according to an embodiment;

FIG. 2 is a flowchart illustrating an exemplary method of setting the dealer's hand according to a house way, according to an embodiment;

FIG. 3 is a flowchart illustrating an exemplary method of implementing a wagering game which uses one or two hands for each of player and dealer, according to an embodiment;

FIG. 4A is a drawing illustrating a gaming table, according to an embodiment;

FIG. 4B is a block diagram illustrating an electronic player tracking system associated with each gaming table, according to an embodiment;

FIG. 5A is a block diagram illustrating exemplary hardware that can be used to implement an electronic version of the methods described herein; and

FIG. 5B is a block diagram illustrating an exemplary network configuration to implement a player playing an online version of the methods described herein.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement a variation of Pai Gow played with cards (instead of tiles). The player is dealt a set of cards and will separate the set of cards into separate hands (a high hand and a low hand). The dealer will then do the same. If both of the player's hands beat the dealer's hands, then the player wins his/her wager. The game can be played with a standard 52 card deck plus one wild joker. When the wild joker is in the dealer's hand, it will take on whatever value possible to give the dealer the best hand possible. When the wild joker is in the player's hand, it will take on whatever value the player wants (typically the best value possible but the player is free to choose).

The player can be dealt four cards in which the player splits into two hands of two cards each. The dealer can be dealt four cards in which the dealer splits into two hands of two cards each. Hand rankings can be used to determine which hand wins (e.g., beats, is higher than) a comparison between the player's hand and the dealer's hand. Table I below illustrates a sample list of ranks, from highest (best) to lowest (worst).

TABLE I

| | |
|---|---|
| 1. | Pair |
| 2. | Wong (K + Q, or K + J) |
| 3. | Gong (Q + J) |
| 4. | Point total (0-9) |

With regard to Table I, higher hands of the same category beat lower hands. For example, a pair of 5's beats a pair of 2's because 5 is higher than 2. Ace is highest, 2 is lowest. A K+Q wong is higher than a K+J wong. Gongs are always equal. The tie breaker for equal point totals is the highest card in the hand. For point totals, ace counts as 1, 2's-9's count as their value, 10's, jacks, queens, and kings all count as 10. If the point total is over 9 then the first digit is removed (e.g., a 7 and a 3 have a point total of zero since the total is 10 so the first digit is removed). This is known as “baccarat scoring” or “modulo 10.” Thus, there can be no point total over 9.

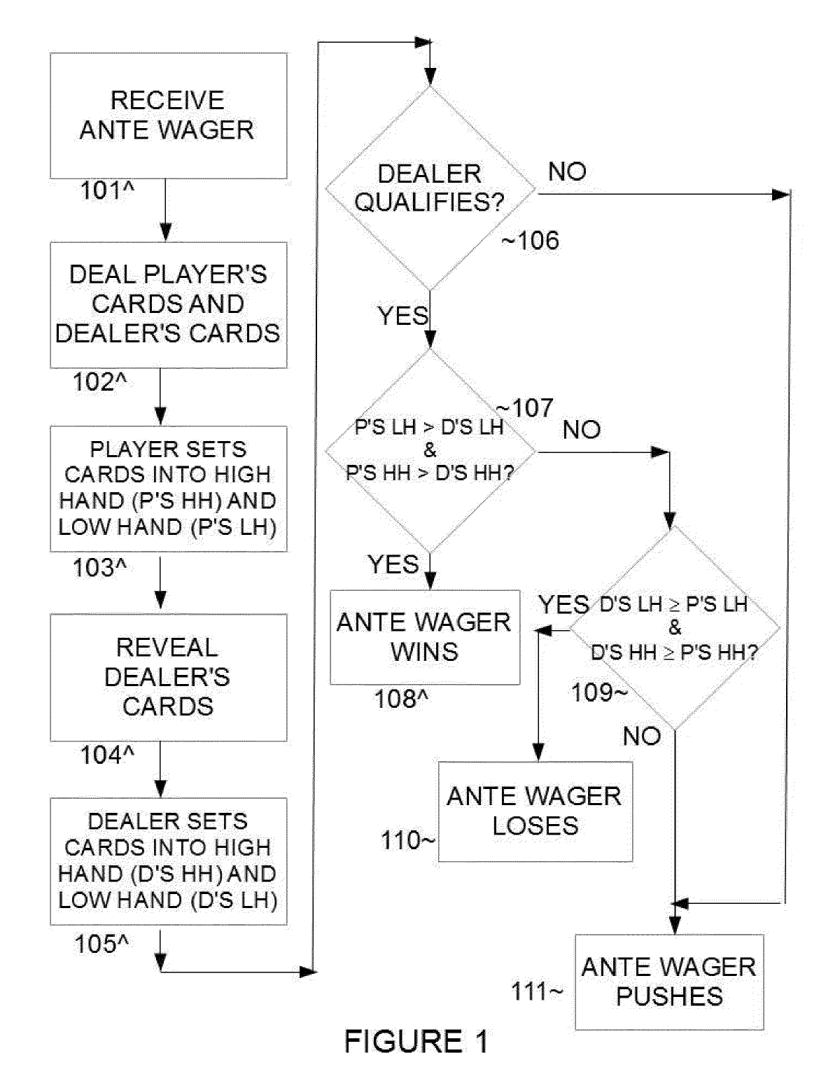

FIG. 1 is a flowchart illustrating an exemplary method of implementing a wagering game which always uses two hands each for player and dealer, according to an embodiment.

The method begins with operation 101, which receives an ante wager from the player. The player can also place an optional side wager(s). Wagers are made by placing physical chips (or cash) on betting circles on the table for this purpose. In the electronic version, wagers are made by placing electronic credits on a forthcoming game using a computer (and winnings are also paid using electronic credits). The ante wager is resolved on a result of the overall game.

Side wagers can be optionally offered by the house and placed by the player. A first side wager can be a “last card bonus wager” and is based on the player's fourth card dealt. Table II below illustrates a sample paytable for the last card bonus wager which can be resolved at the end of the game or immediately after the player's fourth card is dealt.

TABLE II

| 4^{th} card | payout |
|---|---|
| Joker | 10 |
| King | 4 |
| Queen | 2 |
| Jack | 1 |
| All others | −1 |
| | (lose) |

Another side wager that can be offered is a pairs bonus wager. The pairs bonus wager pays on combinations of the player's four cards (it does not matter how the player sets/splits his/her hand). Table III below is an example paytable for the pairs bonus wager. The pairs bonus wager can be resolved immediately after the player's four cards are dealt or at the end of the game. All payouts described herein are “to one” (:1), in other words a payout of 100 means “100:1”.

TABLE III

| 4 card hand | payout |
|---|---|
| Natural four of a kind | 100 |
| Wild four of a kind | 50 |
| Two pairs | 12 |
| Three of a kind | 5 |
| One pair | 1 |
| All others | −1 |
| | (lose) |

From operation 101, the method proceeds to operation 102, which deals player's cards and dealer's cards. Any number of cards can be dealt, but in an embodiment the player is dealt four cards and the dealer is dealt four cards (face down). The player's cards are either dealt face up or face down with the player having the ability to view his/her cards.

From operation 102, the method proceeds to operation 103, wherein the player sets his/her cards into a player's high hand (“P's HH” for short) and a player's low hand (“P's LH” for short). In other words, one hand (the high hand) must be higher than the other hand (the low hand). The player takes his/her four cards and physically breaks them into two separate hands on the table. The table can optionally have an imprint on the felt where the high hand and the low hand should go.

Once the player (and all players at the table who play simultaneously against the dealer) have set their hands, then the method proceeds to operation 104, which reveals the dealer's cards (by turning them face up or dealing them face up now instead of in operation 102).

From operation 104, the method proceeds to operation 105, wherein the dealer sets the dealer's cards (four cards although in other embodiments it can be other amounts) into two separate hands of two cards each (a dealer's high hand and a dealer's low hand) using a “house way.” The dealer will physical break (separate) the dealer's cards into two separate hands of two cards each and place the two cards on the felt so it is clear to all players which two cards form the dealer's high hand and which two cards form the dealer's low hand. The house way is a predetermined methodology for setting the dealer's cards by the dealer so that the dealer has no discretion whatsoever in how to set the hand. Generally, the house way comprises two rules: 1) never break a pair; and 2) otherwise, set the highest low hand possible. In other words, if the dealer's four cards contains a pair, the dealer will always play that pair in the high hand. Otherwise, if the dealer doesn't have a pair, then the dealer will make the low hand as close to the high hand as possible. More on the house way will be discussed below.

From operation 105, the method proceeds to operation 106, which determines whether the dealer qualifies. The dealer qualifies if the dealer's high hand is a pair or if the dealer's low hand has a rank of 3 points or higher (the dealer qualifies if both of these conditions are satisfied as well). In other embodiments, different dealer qualifiers can be used as well. If the dealer does not qualify, then the method proceeds to operation 111, wherein the ante wager (made in operation 101) pushes (neither wins nor loses) and the game ends.

If in operation 106, it is determined that the dealer qualifies, then the method proceeds to operation 107, which determines if the player's low hand beats the dealer's low hand and the player's high hand beats the dealer's high hand. In other words, if each of the two player's hands beats each of the two respective dealer's hands. If yes, then the method proceeds to operation 108, in which the ante wager wins and is paid even money (1:1) or another multiple and the game ends. The word “beats” as used herein means ranks higher, better, etc. In Table I, the higher the rank the better it is.

If in operation 107, it is determined that the condition of the player's low hand beats the dealer's low hand and the player's high hand beats the dealer's high hand is not satisfied, then the method proceeds to operation 109. In operation 109, it is determined whether the dealer's low hand is better or equal to the player's low hand and the dealer's high hand is better or equal to the player's high hand. “Better or equal to” means the hand either ties or is better (e.g., beats, is higher than) than the one it is being compared to. Some hands can tie, for example if the player's high hand is a pair of 3's and the dealer's high hand is a pair of 3's these hands would tie (one is not better than the other). If the condition in operation 109 is true, then the method proceeds to operation 110, in which the ante wager loses (is taken by the house/casino/dealer) and the game ends.

If the condition in operation 109 is not true, then the method proceeds to operation 111, in which the ante wager pushes (neither wins nor loses) and the game ends.

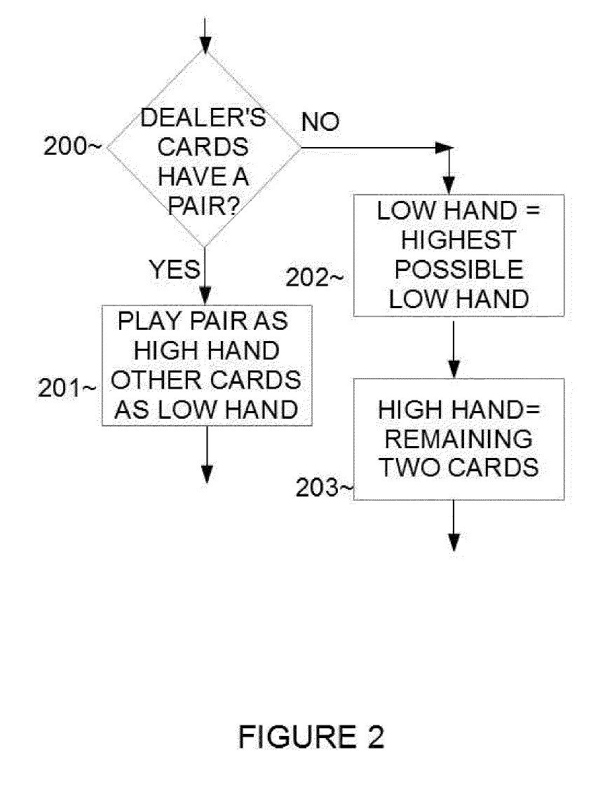

In operation 105, the dealer implements the house way to set the dealer's cards into two separate hands. FIG. 2 is a more detailed illustration of operation 105.

FIG. 2 is a flowchart illustrating an exemplary method of setting the dealer's hand according to a house way, according to an embodiment.

In operation 200 it is determined whether there is a pair in the dealer's four cards. If not, then the method proceeds to operation 202.

If in operation 200, there is a pair in the dealer's four cards then that pair becomes the dealer's high hand and the remaining two dealer's cards become the dealer's low hand. If the dealer's four cards comprise two pairs, then the dealer would use the higher pair for the high hand and the lower pair for the low hand.

In operation 202, the low hand is determined to be the highest possible low hand. This can be determined as follows. There are six possible two card hands. For each of these six hands, it is determined which are low hands by taking the remaining two cards and if the remaining two cards rank higher then the hand is a low hand otherwise it cannot be a low hand. For all of the possible low hands, the highest ranking low hand is used for the low hand and the remaining two cards are used for the high hand. For example, consider the dealer's four cards are: Ace, 4, 8, 9. the possible six hands are: A4, A8, A9, 48, 49, 89. The remaining cards (high hand) are then determined for each of the possible six hands: A4/89, A8/49, A9/48, 48/A9, 49/A8, 89/A4. Using Table I, we determine which are the possible low hands (because they rank lower than the cards used for the high hand): A4, A9, 49. Of these three possible low hands, we take the highest, which is A4 (point total of 5 which is higher than the point total of the others). Thus, according to the house way, the dealer uses A4 for the low hand and 89 for the high hand.

An example of the game will now be presented. Joe places a $1 ante wager. Joe is dealt a 8-hearts/3-diamonds/5-hearts/8-spades. The dealer deals the dealer's four cards face down. Joe sets his hand as follows: 3-diamonds/5-hearts (low hand) and 8-hearts/8-spades (high hand). The dealer then reveals the dealer's hand to be 2-spades/9-clubs/ace-hearts/2-hearts. According to the house way, the dealer sets his hand as 2-spades/2-hearts (high hand) and ace-hearts/9-clubs (low hand). The dealer sets the hand this way since the dealer has a pair, the pair must be used as the dealer's high hand. The dealer qualifies (see operation 106) since the dealer's high hand has a pair. So the ante wager is now resolved based on a comparison of hands. The player's high hand is higher than the dealer's high hand because a pair of 9's ranks better than a pair of 2's. The player's low hand has a score of 8 and the dealer's low hand has a score of 0 (aces count as 1 so 9+1=10 and using modulo 10 scoring 10 becomes 0), so the player's low hand is higher than the dealer's high hand (“is better” is equivalent to saying “ranks better”, “is higher”, “ranks higher”, etc.) Thus, both player's hand beat their respective dealer hands (e.g., the player's high hand is compared to the dealer's high hand and the player's low hand is compared to the dealer's low hand), so the player wins a payout on the ante wager (typically an even money payout of 1:1 although it can be other payouts as well). The game is now over.

In another embodiment, a different but similar method can be used to implement a wagering game. In this embodiment, both the player and dealer are each dealt five cards and can make either one five card hand or two hands (a three card hand and a two card hand). This is in contrast to the previous method in which the player and dealer will always split their cards into two separate hands.

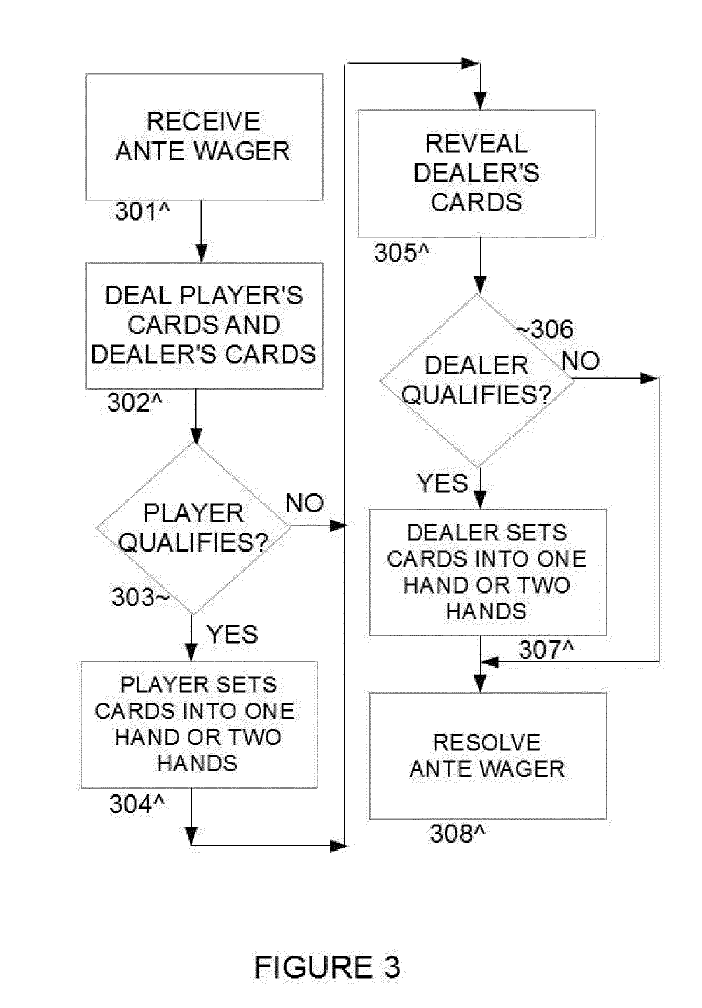

FIG. 3 is a flowchart illustrating an exemplary method of implementing a wagering game which uses one or two hands for each of player and dealer, according to an embodiment. This embodiment can also be played with a standard 52 card deck plus a joker. Unlike the prior embodiment illustrated in FIG. 1 (where the joker can take on any value), in this embodiment the joker can only be used as an ace or to complete a straight or a flush (in other words if the joker cannot complete a straight or a flush then it becomes an ace).

The method can begin with operation 300, which receives the ante wager from the player. The player can place a chip (or cash) in a betting circle on the table designated for this purpose. The player can also place any optional side wager(s).

The method proceeds to operation 302, which deals the player's cards and the dealer's cards. The player is dealt five cards and the dealer is dealt five cards, although in other embodiments other amounts of cards can be used. The dealer's cards are typically dealt face down while the player's cards are dealt face up (or if dealt face down the player has the ability to view his/her cards).

From operation 302, the method proceeds to operation 303, which determines whether the player qualifies. The player qualifies if the player's cards (dealt in operation 302) satisfy a predetermined condition. In order to qualify, the player must set his/her hand into either a 5 card hand with a straight or better or a two separate hands which must have either an ace or a pair in a two card hand and a three card hand. If the dealer cannot make a five card hand or a two card hand (with an ace or a pair) then the player does not qualify. In other embodiments, a different player qualifying condition can be used. If the player does not qualify then the method proceeds to operation 305.

If in operation 303 the player qualifies, then the method proceeds to operation 304, wherein the player sets hits cards into one or two hands (at the player's choice). However, the hands the player sets must meet the qualification condition from operation 303. In other words, if the player makes a five card hand it must rank at least a straight, and if the player makes two hands the two card hand must have an ace or a pair. Thus, in operation 304, the player leaves the five cards intact to indicate he/she is making one five card hand, or separates the hand into two hands (a two card hand and a three card hand) to indicate the player is making two cards. Since the player's cards are typically dealt face up the dealer can verify that the hand(s) the player is making meet the qualification criteria. If the player is dealt a straight (e.g., 3-spades, 4-clubs, 5-diamonds, 6-clubs, 7-clubs) then the player would not be able to play this as two hands because then the player wouldn't qualify (since the player cannot make a two card hand with a pair or with an ace).

From operation 304, the method proceeds to operation 305 which reveals the dealer's cards. This is typically done by turning face up the cards dealt in operation 302, or alternatively by dealing the dealer's card in operation 305 all face up.

From operation 305, the method proceeds to operation 306 to determine whether the dealer qualifies. The dealer qualifying condition is the same as the player qualifying condition, that is, the dealer must make either a five card hand (with a rank of at least a straight) or a two card hand (with an ace or a pair) and a three card hand, to qualify. If the dealer does not qualify, then the method proceeds to operation 308.

If in operation 306, the dealer does qualify, then the method proceeds to operation 307 wherein the dealer sets the dealer's card into one hand or two hands according to a house way. The house way is enumerated in Table IV which lists prioritized rules (start from rule 1 and work down to rule 5). If there is more than one way to make a two card hand according to the house way, then the cards chosen would be the ones which make the best three card hand (for example, if the dealer is dealt a 2-spades/2-diamonds/5-diamonds/2-hearts/10-diamonds, then the dealer would use the 2-spades/2-diamonds for the two-card hand and the 5-diamonds/2-diamonds/10 diamonds for the three card hand so the three card flush is not broken). Note that rule 2 means that the dealer would play the best ace-high or better hand only if the dealer's three card hand would be a three card flush or better. For example, if the dealer's cards are 6-diamonds/6-hearts/7-spades/8-spades/ace-spades, in rule 2 the dealer would make a two card hand of 6-diamonds/6-hearts and a three card hand (flush) of ace-spades/7-spades/8-spades (instead of ace-spades/6-diamonds and (straight) 6-hearts/7-spades/8-spades). As another example of rule 2, if the dealer is dealt 6-diamonds/6-spades/7-spades/8-spades/ace-spades, the dealer would play 6-diamonds/6-spades and 7-spades/8-spades/ace-spades (instead of ace-spades/6-diamonds and (straight flush) 6-spades/7-spades/8-spades). This is because the pair of 6's is the best ace-high or better two card hand that can be made (as specified in rule 2 in Table IV).

TABLE IV

| | |
|---|---|
| 1. | Play a 5-card hand if straight or better |
| 2. | Play the best ace-high or better 2-card hand with a |
| | three card flush or better |
| 3. | With two pairs, play the highest pair in the 2-card hand. |
| 4. | With a pair, play the pair in the 2-card hand. |
| 5. | Play ace with third highest card in the 2-card hand. |

From operation 307 (or 306) the method proceeds to operation 308, which resolves the ante wager. The ante wager is resolved based on what has previously taken place in the game and is resolved by use of a table such as Table V. Note that a 5 card hand always beats a 2 card hand plus a three card hand.

TABLE V

| Outcome | Result |
|---|---|
| Neither player nor dealer qualifies | Player wins 50% of wager |
| Player qualifies, dealer does not qualify | Player wins 50% of wager |
| Dealer qualifies, player does not qualify | Player loses wager |
| Both Player and Dealer Qualify: | |
| Dealer wins with 5-card hand | Player loses wager |
| Player wins with 5-card hand | Player wins according to |
| | 5-Card Hand Bonus Pay Table |
| Dealer and player tie 5-card hands | Push |
| Player and Dealer each win one hand | Push |
| Player and Dealer tie both hands | Push |
| Dealer wins one hand, ties the other hand | Player loses wager |
| Player wins one hand, ties the other hand | Player wins wager |
| Dealer wins both hands | Player loses wager |
| Player wins both hands | Player wins wager |

If the player wins with a 5-card hand, then the player wins a payout based on a 5-card hand bonus pay table, such as that illustrated in Table VI. Of course these payouts (and all used herein) are merely examples and can be changed by the game designers. Note that when a five card player's hand is compared to a five card dealer's hand, a table such as Table VI can be used to determine which hand ranks better (ranks are listed in Table VI from best (top) to worst (bottom). Tie ranks can be broken based on which hand has the highest card, for example a flush with 4/5/10/Q/3 would beat a flush with 2/4/5/7/9 because the former hand has a higher ranking card.

TABLE VI

| Hand Rank | Payout |
|---|---|
| Five Aces | 200:1 |
| Royal Flush | 100:1 |
| Straight Flush | 50:1 |
| Four of a Kind | 20:1 |
| Full House | 8:1 |
| Flush | 3:1 |
| Straight | 2:1 |
| All others | −1 (lose) |

The player's three card hand can be compared to the dealer's three card hand and the winning (better) hand can be determining using a predetermined ranking such as that in Table VII. Hands are listed from best to worst.

TABLE VII

Straight flush
Three of a kind
Straight
Flush
Pair
High card

The player's five card hand can be compared to the dealer's five card hand and the winning (better) hand can be determined using a predetermined ranking such as that illustrated in Table VIII. Hands are listed from best to worst.

TABLE VIII

Five Aces
Royal Flush
Straight Flush
Four of a kind
Full House
Flush
Straight

The player's two-card hand can be compared to the dealer's two card hand and the winning (better) hand can be determined using a predetermined ranking such as that illustrated in Table IX. Hands are listed from best to worst.

TABLE IX

Pair
High card

An example of the second embodiment of the game (illustrated in FIG. 3) will now be presented. Kim places a $1 ante wager. The player is dealt five cards face up: 8-diamons/7-spades/10-clubs/6-hearts/9-spades. The dealer is dealt five cards face down. The player qualifies (operation 303) since the player has a five card straight. The player must play the five card straight as a five card hand (otherwise the player wouldn't qualify by making two hands). The dealer now reveals the dealer's cards to be: 8-hearts/queen-clubs/8-spades/8-clubs/2-clubs. The dealer qualifies since the dealer can make a two-card pair. The dealer must play the pair of 8's (8-hearts/8-spades) as the two card hand and the 8-clubs/queen clubs/2-clubs as the three card hand. The 8-hearts and 8-spades are used for the two card hand because this leaves the 8-clubs for the three card hand which makes a flush in the three card hand. If the dealer's 2-clubs was a 2-hearts instead, then the suit of the 8′ chosen for the 2-card hand would not matter and can be chosen randomly. The dealer qualifies because the dealer meets the qualifying conditions in this case by having a pair in the two card hand. Thus, the ante wager is resolved based on using a table such as that in Table V.

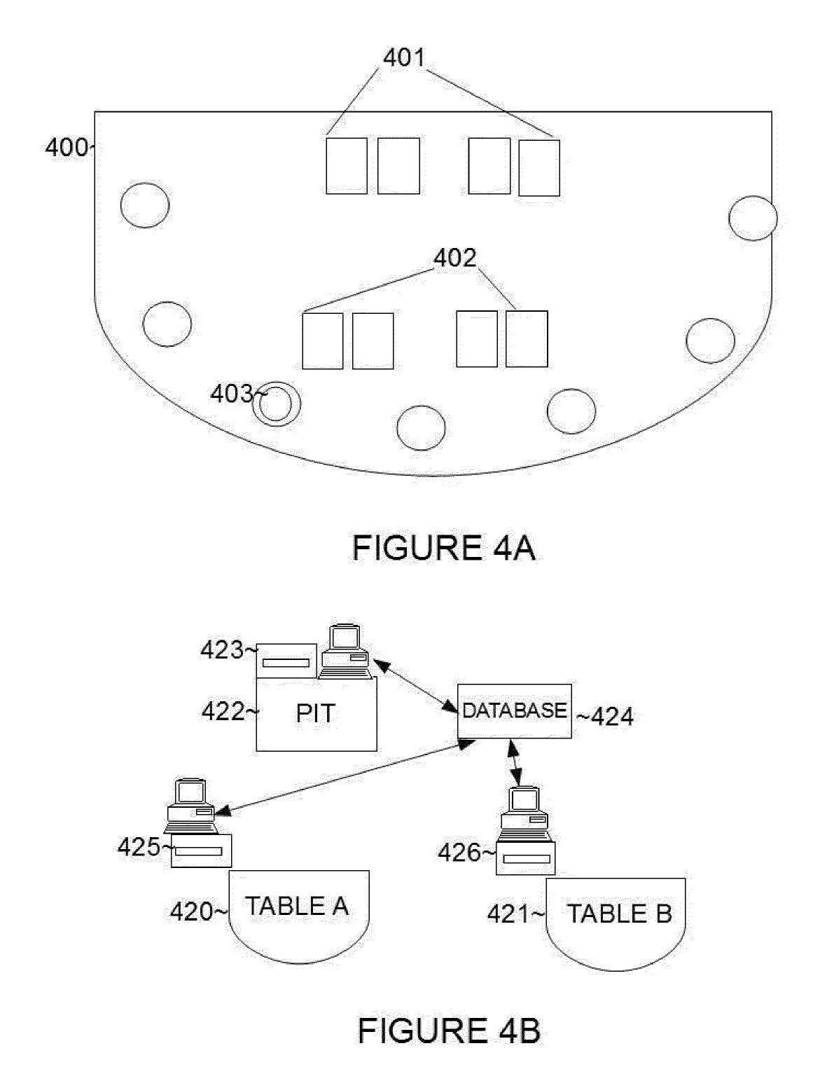

FIG. 4A is a drawing illustrating a gaming table, according to an embodiment.

A physical gaming table 400 (typically made of wood with felt on top with the layout imprinted on it) is used to play the game in a physical real world casino. One example of a table that can be used in a physical casino is illustrated in U.S. Design Pat. No. D263,975 which is incorporated by reference herein in its entirety. The layout on top of the felt has imprinted on it seven betting circles as illustrated in FIG. 4A, each betting circle is where the respective player can place their chips (wager). The felt can be green and the imprinted betting circles can be white, although of course any color scheme can be used. Such a table can accommodate any number of players (such as seven as illustrated) or any other number (e.g. 2-10). All players play simultaneously against the dealer as known in the art. A player's high hand and low hand 402 and a dealer's high hand and low hand 401 are shown. A player's wager 403 is shown in the form of a chip or chips and is placed inside the player's betting circle.

While not shown, the game can also be offered with any type of additional side wager in order to generate more action for the casino and more excitement for the players. Also not pictured in FIG. 4A is an electronic mechanical shuffler such as that described in U.S. Pat. No. 8,025,294 which is incorporated by reference here in its entirety which can optionally be used by the dealer to shuffle the deck or decks of cards. Also not pictured in FIG. 4A is an optional shoe which the cards can be placed into and dealt out of by the dealer, such as the shoe described in U.S. Pat. No. 4,457,512 which is incorporated by reference herein in its entirety.

FIG. 4B is a block diagram illustrating an electronic player tracking system associated with each gaming table, according to an embodiment.

When players play casino table games the casino can typically track the player so that the casino knows how much gaming action a player is giving the casino and hence how much to reward each player with complimentaries (free or discounted rooms, food, etc.) Such a system is described in U.S. Pat. No. 5,836,817, which is incorporated by reference herein in its entirety for all purposes. Each player can have their own players card which is a plastic card that has their name imprinted on it and computer readable indicia (e.g., a magnetic stripe) which stores an identification number of the player's card (and hence the identification number of the player who owns the card). The player's card can be swiped through an electronic card readers 423, 425, 426 which can be electronic read and the data therein transmitted to the associated computer.

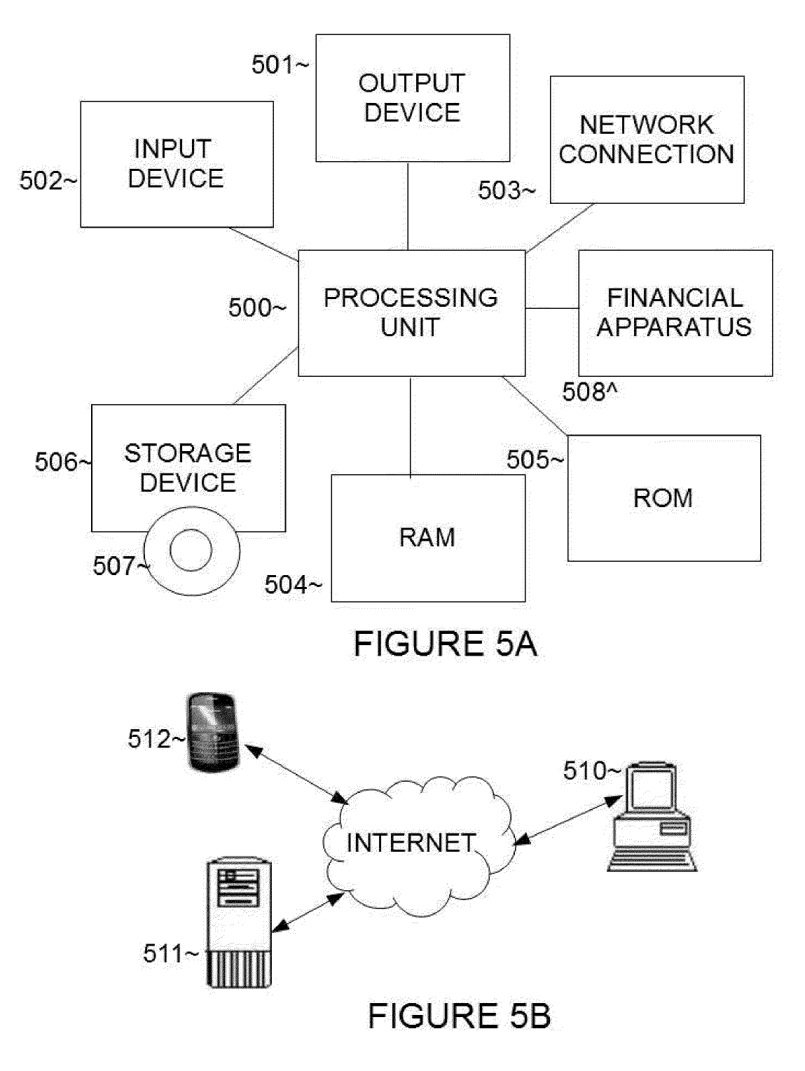

A gaming table A 420 (which can be used to play any method described herein) and a gaming table B 421 (which can be used to play any method described herein) can be associated with a pit 422 (which has its own computer) which has a card reader 423 to read the electronically encoded information on a player's card (the card reader can also be located at the tables themselves) and transmit the information to an associated computer which can communicate information contained on the player's card (e.g., an identification number of the player associated with the card) to the electronic database 424 along with play data relating to the player who owns the player's card. Table A 420 has its own card reader 425 and associated computer (the one next to card reader 425 which receives information from the card reader 425) and table B 421 also has its own card reader 326 and associated computer (the one next to card reader 426 which receives information from the card reader 426). The computers at table A 420 and table B 421 are connected to the electronic database 424. Casino employees can enter data regarding each player's play (for those players that present a players card) into a computer at the table or at the pit which transmits the play data (e.g., average wager amount, time of play, etc.) to the electronic casino database 424 that stores playing history information for players at the casino. The computers illustrated in FIG. 4B can all have the structure as illustrated in FIG. 5A.

FIG. 5A is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The hardware can also be any computing device, such as a cellular phone, tablet, etc., and the methods described herein can be installed as software (e.g., an app) on the device. The hardware can also be any other type of device, working individually or in conjunction with other devices. The hardware can also be a digital poker table, of the kind described in U.S. Pat. No. 7,758,411 which is incorporated by reference herein in its entirety.

A processing unit 500 (such as a microprocessor and any associated components) is connected to an output device 501 (such as an LCD monitor, touch screen, CRT, etc.) which is used to display to the player any aspect of the method, and an input device 502 (e.g., buttons, a touch screen, a keyboard, mouse, etc.) which can be used to input from the player any decision made by the player. All methods described herein can be performed by the processing unit 500 by loading and executing respective instructions. The processing unit 500 can also be connected to a network connection 503, which can connect the electronic gaming device to a computer communications network such as the Internet, a LAN, WAN, etc. The processing unit 500 is also connected to a RAM 504 and a ROM 505. The processing unit 500 is also connected to a storage device 506 which can be a DVD-drive, CD-ROM, flash memory, etc. Multiple such processing units can also work in collaboration with each other (in a same or different physical location). A non-transitory computer readable storage medium 507 can store a program which can control the electronic device to perform any of the methods described herein and can be read by the storage device 506. The processing unit 500 can also be connected to a financial apparatus 508 which can receive cash and convert the received cash into playable credits for use by the player when playing the electronic device. When the player decides to cash out any remaining credits, the financial apparatus 508 can issue coins or a cashless ticket (voucher) for the remaining credits which is redeemable by the player.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

FIG. 5B is a block diagram illustrating an exemplary network configuration to implement a player playing an online version of the methods described herein. All the methods described herein can be implemented on an online casino for real money (credits which are purchased for cash and are redeemable for cash) or for non-cash value credits. A player uses a personal computer 510 (e.g., cell phone, tablet, PC, etc.) can connect to a server 511 (which can have the structure illustrated in FIG. 5A) using a computer communications network such as the Internet. The server 511 hosts an online casino which determines the outcomes of the game and serves the outcomes to the computer 510 so the computer 510 displays the outcomes to the player. Other users can also play at the online casino hosted by the server 511 simultaneously, such as using a cell phone 512 with wireless internet connectivity. Any number of players connected to the internet can play contemporaneously at the sever 511. The general structure of online casinos is well known in the art.

It is noted that the methods described herein can be played with any number of standard decks of 52 cards (e.g., 1 deck to 10 decks). A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied. Note that the number of cards used for each hand can vary and different sized hands can be used.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real life image of that card.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for implementing a game, the method comprising:
providing an electronic input device and an electronic output device and an electronic processor connected to the input device and the output device;
executing instructions on the processor which perform:
receiving a wager from a player;
dealing a player's set of cards to the player and a dealer's set of cards to the dealer;
enabling the player to set the player's set of cards into a player's low hand and a player's high hand;
setting the dealer's set of cards using a house way into a dealer's low hand and a dealer's high hand; and
resolving the wager based on a set of resolution rules, wherein the resolution rules comprise: if the player's low hand beats the dealer's low hand and the player's high hand beats the dealer's high hand then the wager wins, and if the dealer's low hand is better or equal to the player's low hand and if the dealer's high hand is better or equal to the player's high hand then the wager loses.

2. The method as recited in claim 1, wherein the resolution rules further comprise if the dealer's low hand is better or equal to the player's low hand and if the dealer's high hand is better or equal to the player's high hand is not true then the wager pushes.

3. The method as recited in claim 1, further comprising, after the setting and before the resolving, determining if the dealer qualifies, and if the dealer does not qualify then the wager pushes.

4. The method as recited in claim 3, further comprising determining whether the dealer qualifies by determining if the dealer's high hand is a pair or if the dealer's low hand is 3 points or higher.

5. The method as recited in claim 1, wherein the house way is a predetermined set of rules comprising: set the dealer's high hand as a pair if the dealer's cards comprise a pair, and if not, then set the dealer's low hand as the highest possible low hand.

6. The method as recited in claim 1, further comprising playing the game with a standard 52 card deck plus a wild joker added.

7. The method as recited in claim 1, wherein point totals for two card hands are computed using modulo 10.

8. The method as recited in claim 1, wherein the player's low hand and the player's high hand and the dealer's low hand and the dealer's high hand all have two cards each.

9. A method for implementing a game, the method comprising:
providing an electronic input device and an electronic output device and an electronic processor connected to the input device and the output device;
executing instructions on the processor which perform:
receiving a wager from a player;
dealing a player's set of N cards to the player and a dealer's set of N cards to the dealer;
enabling the player to choose to set the player's set of cards to the player's choice of 1) a player's A card hand 2) a player's B card hand and a player's C card hand;
the dealer choosing to set the dealer's set of cards into to the dealer's choice of 1) a dealer's A card hand 2) a dealer's B card hand and a dealer's C card hand, using a house way; and
resolving the wager based on a set of resolution rules.

9. The method as recited in claim 8, wherein N=5, A=5, B=2 and C=3.

10. The method as recited in claim 8, further comprising determining whether the player qualifies by determining if the player is able to set the player's set of cards into a predetermined N card hand or a predetermined B card hand.

11. The method as recited in claim 8, further comprising determining whether the dealer qualifies by determining if the dealer is able to set the dealer's set of cards into a predetermined N card hand or a predetermined B card hand.

12. The method as recited in claim 8, further comprising the player making a single hand of A cards, and upon the player winning the wager paying the player a bonus based on the A card hand using a paytable.

13. The method as recited in claim 8, further comprising enabling the player to make a single hand of A cards and the dealer making a single hand of A cards, and determining a winner based on a comparison between the player's A card hand and the dealer's A card hand.

14. The method as recited in claim 8, further comprising providing a rule in which an A card hand always beats a B card hand plus a C card hand.

15. The method as recited in claim 8, further comprising providing a rule wherein if the player does not qualify and the dealer does not qualify then the player wins a portion of the wager.

16. The method as recited in claim 15 wherein the portion is 50%.

17. The method as recited in claim 8, further comprising providing a rule wherein if the dealer qualifies and the player does not qualify then the player loses the wager.
